(19) United States
(12) Patent Application Publication
(10) Pub. No.: US 2018/0372910 A1
(43) Pub. Date: Dec. 27, 2018

(54) METHOD FOR FLEXIBLE STRUCTURED GRIDDING USING NESTED LOCALLY REFINED GRIDS

(71) Applicant: Halliburton Energy Services, Inc., Houston, TX (US)

(72) Inventors: Sheldon Burt Gorell, Katy, TX (US); Ali Dortaj, Houston, TX (US); Guoqiang Su, Katy, TX (US)

(21) Appl. No.: 15/777,156

(22) PCT Filed: Mar. 1, 2016
(86) PCT No.: PCT/US2016/020215

§ 371 Date: May 17, 2018

(51) Int. Cl. G01V 99/00

(52) U.S. Cl. CPC G01V 99/005

(57) ABSTRACT

A computing system includes a display and a processor coupled to the display. The processor is configured to: identify a particular area in a representation of a geologic formation displayed on the display; control the display to display a grid block to encompass the particular area, without reference to one or more underlying grid boundaries; control the display to display a plurality of buffer grid blocks adjacent to the grid block; and refine a resolution of the grid block. Controlling the display to display the grid block without reference to the one or more underlying grid boundaries allows the resolution of the grid block to be refined without restriction by the one or more underlying grid boundaries.

### BACKGROUND

Reservoir simulation is an area of reservoir engineering that employs computer models to predict the transport of fluids, such as oil, water, and gas, within a reservoir. Reservoir simulators are used by petroleum producers in determining how best to develop new fields, as well as generate production forecasts on which investment decisions can be based in connection with developed fields.

Reservoir simulation software models are typically implemented using a number of discretized blocks, referred to interchangeably herein as “blocks,” “grid blocks,” or “cells.” Models can vary in size from a few grid blocks to hundreds of millions of grid blocks. In these software simulations, it is common to model a reservoir using a simulation grid formed of blocks and then simulate reservoir properties (e.g., pressure, temperature, porosity, permeability) within each block to predict flow. For example, such modeling may be particularly useful in low permeability reservoirs for determining how many and where fractures should be induced in a reservoir to achieve a certain flow over a period of time.

### BRIEF DESCRIPTION OF THE DRAWINGS

There are disclosed in the drawings and the following description methods and systems employing grid blocks for modeling a geologic formation. In the drawings:

FIG. 1 illustrates an example of a simulation grid;

FIG. 2 illustrates an example of a locally refined grid selected within the simulation grid;

FIG. 3 is an enlarged view of the locally refined grid;

FIGS. 4(a), 4(b), and 4(c) illustrate construction of a simulation grid according to one embodiment;

FIG. 5 illustrates an example in which a grid block around an area of interest is refined;

FIG. 6 illustrates an example in which multiple grid blocks around an area of interest are refined;

FIG. 7 illustrates an example of a uniform refinement of a grid block in an area of interest;

FIG. 8 illustrates an example of a non-uniform refinement of a grid block;

FIGS. 9 and 10 illustrate construction of a simulation grid according to one embodiment;

FIGS. 11 and 12 illustrate examples of uniform and/or non-uniform refinement of multiple grid blocks;

FIG. 13 is a flowchart showing an illustrative modeling method; and

FIG. 14 is a simplified block diagram of a computer system adapted for implementing a reservoir simulation system.

It should be understood, however, that the specific embodiments given in the drawings and detailed description do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

Disclosed herein are methods and systems for modeling a geologic formation using grid blocks. In at least some embodiments, a method includes identifying a particular area (or two or more areas) in a representation of the geologic formation and providing a grid block to encompass the particular area, without reference to one or more underlying grid boundaries. The method also includes providing a plurality of buffer grid blocks adjacent to the grid block and refining a resolution of the grid block. Providing the grid block to encompass the particular area without reference to the one or more underlying grid boundaries allows the resolution of the grid block to be refined without restriction by the one or more underlying grid boundaries.

A related computing system includes a display and a processor coupled to the display. The processor is configured to: identify a particular area (or two or more areas) in a representation of a geologic formation displayed on the display; control the display to display a grid block to encompass each particular area, without reference to one or more underlying grid boundaries; control the display to display a plurality of buffer grid blocks adjacent to the grid block; and refine a resolution of the grid block. Controlling the display to display the grid block to encompass the particular area without reference to the one or more underlying grid boundaries allows the resolution of the grid block to be refined without restriction by the one or more underlying grid boundaries.

Reservoir simulation commonly utilizes numerical representations of a reservoir based off the physics, either as the reservoir currently exists or as it is envisioned to exist at some point in the future, e.g., before any wells are drilled, prior to any field development and during field development. Such a representation of the reservoir, combined with additional data about proposed or existing wells and development strategy, facilitates prediction of how the reservoir might perform in terms of reservoir stimulation and production.

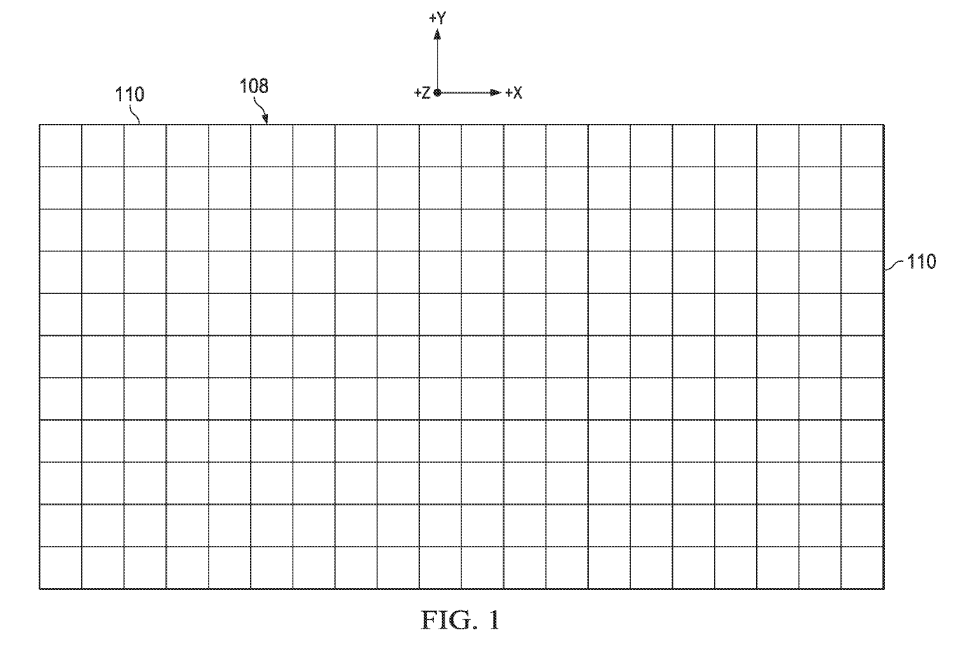

The simulation may utilize a grid. FIG. 1 illustrates an example of a simulation grid 108. The simulation grid 108 is applied to a geologic formation such as a subterranean reservoir. The simulation grid 108 is characterized by (or divided into) grid blocks 110. Each of the grid blocks 110 represents a respective portion of the reservoir. Therefore, a particular grid block 110 is used to discretely characterize a corresponding portion of the reservoir. For example, reservoir engineering data may be collected on a grid block level. A functional model of the reservoir may be created by simulating reservoir properties such as flow rate, pressure, temperature, porosity, and permeability within each grid block 110.

In the FIG. 1, the grid blocks 110 are illustrated as being substantially uniform in shape and size. However, it is understood that the grid blocks 110 may have different shapes and/or sizes. For example, any two or more of the grid blocks 110 may have different sizes, in order to represent portions of the reservoir having different sizes. Further, along a particular direction (e.g., x-direction, y-direction), the simulation grid 108 may be divided into any of various numbers of grid blocks 110.

For ease of description, the simulation grid 108 is described as being composed of grid blocks 110 that reside in one plane (e.g., an x-y plane). However, it is understood that features disclosed herein are equally applicable to a simulation grid composed of grid blocks that reside in other planes (e.g., an x-z plane) as well as a simulation grid composed of three-dimension grid blocks that are defined by the x-, y- and z-directions.

As noted earlier, the simulation grid 108 may be used to model a reservoir. The reservoir may be a shale reservoir. Typically, shale reservoirs exhibit a permeability that is quite low when compared to other types of geologic reservoirs. For example, shale reservoirs may be less permeable than other geologic reservoirs by a factor of 10′. Lower levels of permeability result in slower fluid and pressure. Increased surface area in contact with such a reservoir can be accomplished by creating fractures. The areas around fractures typically require fine grids in order to suitably capture pressure transient behavior. Accordingly, it is often beneficial to model certain portions of a shale reservoir (e.g., to model parameters such as flow) using a finer grid scale as compared to other portions of the reservoir or other types of reservoirs. Such other reservoirs may be modeled acceptably using grid blocks that are less refined.

Further, the reservoir may include one or more geologic features or areas of interest, such as the fractures described earlier, wellbores or the like. Such features may be either man-made or naturally occurring. For example, a particular structure may be an existing structure of the reservoir or a proposed structure selected to achieve a particular flow in a modeled formation.

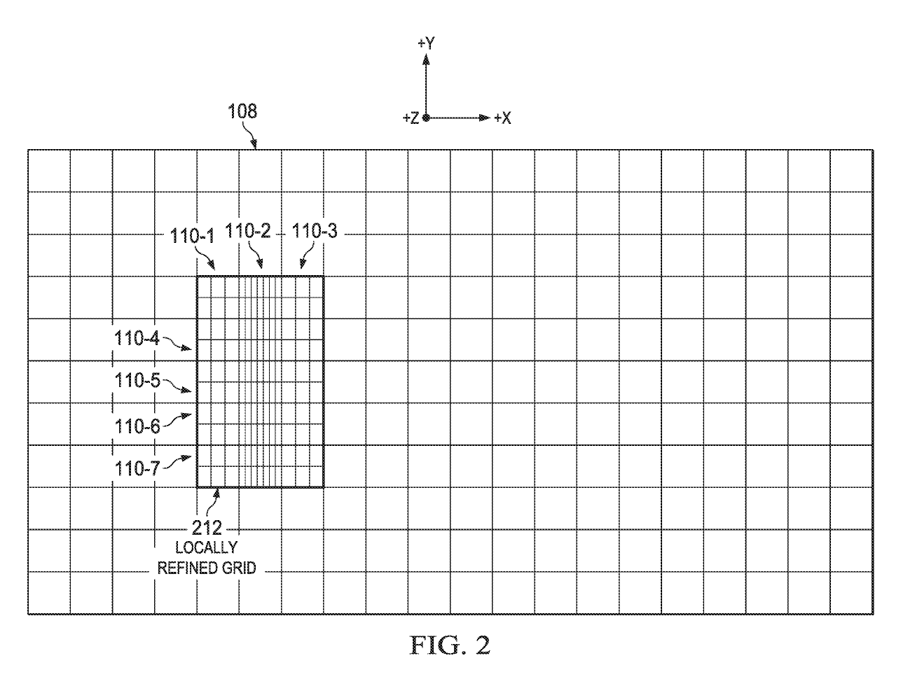

The simulation grid 108 may be used to simulate pressure flow at a number of discrete locations around the structure (e.g., an existing or a proposed fracture). Ultimately, this model predicts the areas of the reservoir in which fluid and/or pressure movement associated with the fracture will occur. To more accurately predict pressure flow in such regions, finer grids can be used to model the region(s) of the reservoir in which significant fluid and/or pressure movement are expected to occur. Such finer grids are commonly referred to as local grid refinements (LGRs). Because the higher resolution associated with LGRs involve heavier computational loads, LGRs are typically applied only to specific areas of interest (e.g., areas around a fracture), such that other areas of the reservoir are modeled using coarser grids. FIG. 2 illustrates the selection of a locally refined grid 212 embedded within the simulation grid 108. The locally refined grid 212 is defined with reference to the simulation grid 108. More specifically, the locally refined grid 212 is defined by borders of the grid blocks 110. As illustrated in the x-direction of FIG. 2, the locally refined grid 212 is 3 grid blocks wide (the locally refined grid 212 is embedded within 3 grid blocks of the simulation grid 108). More specifically, in the x-direction, a topmost border of the locally refined grid 212 is defined by (or coincident with) borders of the grid blocks 110-1, 110-2, and 110-3. In the y-direction of FIG. 2, the locally refined grid 212 is 5 grid blocks long. More specifically, in the y-direction, a leftmost border of the locally refined grid 212 is defined by borders of the grid blocks 110-1, 110-4, 110-5, 110-6, and 110-7. For purposes of reducing computational load, the locally refined grid 212 is sized so as to reduce unnecessary application of fine grids in a reservoir simulation model. Accordingly, the size of the locally refined grid 212 is based on the size of an area of interest.

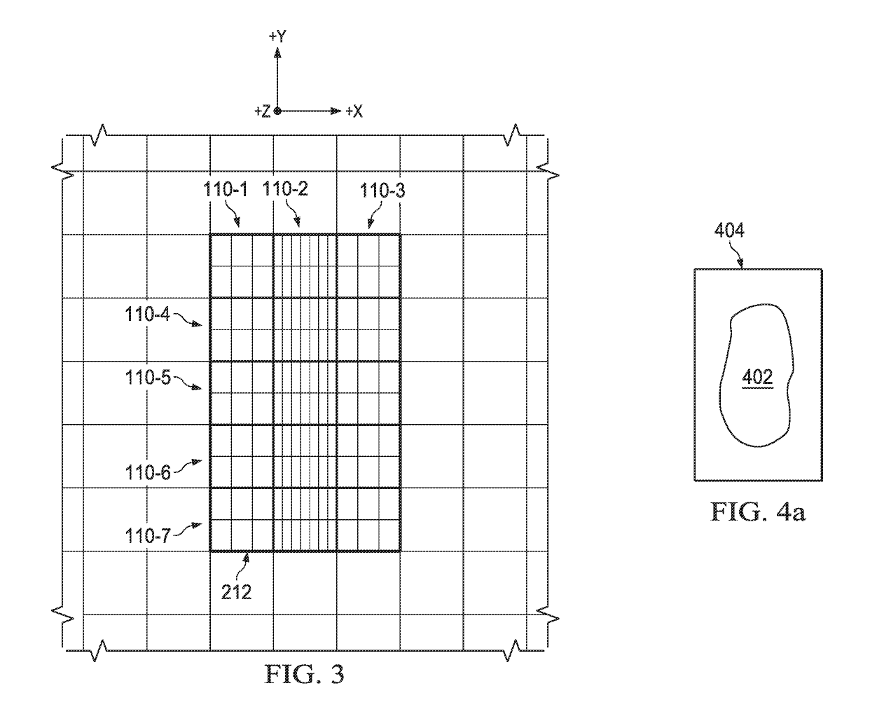

An LGR is applied to the simulation grid. The application of the LGR is illustrated more clearly in FIG. 3, which is an enlarged view of the locally refined grid 212 of FIG. 2. One or more grid blocks that are within the locally refined grid 212 are sub-divided into a plurality of smaller (i.e., finer) grid blocks. Thus, when the reservoir model is simulated, pressure and/or fluid movement may be discretely calculated for each finer grid block to achieve a more accurate simulation.

As illustrated in FIG. 3, resolution in one or more blocks within the locally refined grid 212 is increased. The increase in resolution may vary across different grid blocks. For example—as illustrated in FIG. 3, resolution in grid blocks 110-1 and 110-3 is uniformly increased by a factor of 3 in the x-direction. In other words, along the x-direction, each of grid blocks 110-1 and 110-3 is evenly divided into 3 (smaller) blocks. For example, resolution in grid block 110-2 is uniformly increased by a factor of 7 in the x-direction. In other words, along the x-direction, grid block 110-2 is evenly divided into 7 (smaller) blocks. More generally, each grid block in the locally refined grid 212 can be sub-divided into any of various numbers of smaller blocks, relative to a particular direction (e.g., x- or y-direction).

Refinement of the locally refined grid 212 is hampered or restricted by the borders of various grid blocks of the simulation grid 108. The locally refined grid 212 is embedded within grid blocks of the simulation grid 108 (e.g., grid blocks 110-1, 110-2, 110-3, etc.) Refinement of the locally refined grid 212 is performed in a manner that is observant of the borders of such grid blocks.

For example, each of grid blocks 110-1, 110-2, 110-3 may represent a width of 100 feet in the x-direction. By uniformly subdividing a particular grid block (e.g., grid block 110-1) into 2, blocks are created, where each represents a width of 50 feet. Similarly, by uniformly subdividing the grid block 110-1 into 3, blocks are created, where each represents a width of 33⅓ feet are created. As such, blocks are created, where each represents a width of 100/N feet, where N denotes an integer greater than 0. However, in cases where 100 feet is not equal to an integer multiple of a particular width (e.g., such as 37 or 47 feet, N would be a non-integer), it is not possible to create equally sized blocks, each of the blocks representing the particular width.

It is recognized that one or more grid blocks may be subdivided in a non-uniform manner. For example, the grid block 110-1 may be subdivided into blocks that represent widths of 37 feet, 47 feet and 16 feet, respectively. However, the refinement of the grid block is confined or restricted, in that the widths represented by the smaller blocks add up to 100 feet (the width represented by grid block 110-1).

According to various embodiments, a coarse grid block is created. The grid block covers a particular area (or structure) of interest, and is defined without reference to an underlying grid such as simulation grid 108 (or grid blocks 110 that make up a simulation grid). Other coarse grid blocks (buffer grid blocks) are created around the grid block, in order to model areas outside of the area of interest. Because the coarse grid block is defined without reference to an underlying simulation grid, refinement of the coarse grid block can be performed without being hampered or encumbered by borders associated with such a simulation grid.

According to various embodiments, a grid for modeling an entire area is constructed based on one or more particular areas of interest (e.g., fracture patterns) that are to be modeled, as well as the size(s) of the particular area(s). A coarse grid block(s) (corresponding to the area(s) of interest) may be refined independent of buffer grid blocks that are provided around the coarse grid block(s).

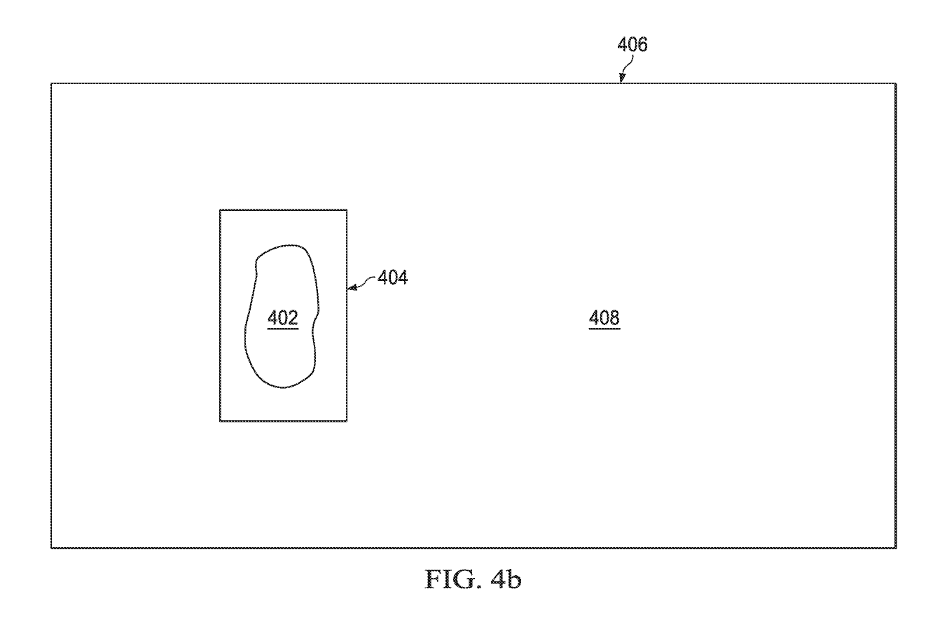

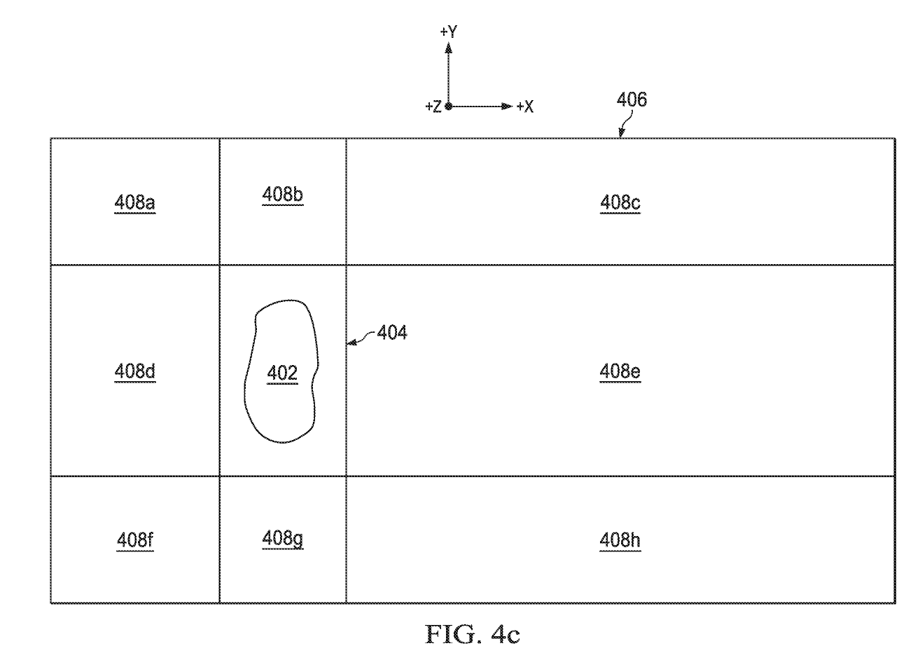

First, a grid that is constructed based on a single area of interest will be described with reference to FIGS. 4(a), 4(b), and 4(c). FIGS. 4(a), 4(b), and 4(c) illustrate construction of a grid according to one embodiment.

In a representation of a geologic formation (e.g., a reservoir such as a shale reservoir), a specific structure 402 is identified. For example, the structure 402 may be a fracture pattern. With reference to FIG. 4(a), a grid block 404 is created to encompass the structure 402. Similar to the locally refined grid 212 of FIGS. 2 and 3, the grid block 404 is for modelling a specific area of interest in a reservoir. However, unlike the locally refined grid 212, the grid block 404 is defined without reference to an underlying grid and/or underlying grid blocks (e.g., simulation grid 108 and/or grid blocks 110 of FIG. 1). As such, the dimensions of the grid block 404 can be selected irrespective of grid lines (or borders) that are associated with such constructs. Further, as will be described in more detail later, the grid block 404 can be refined (e.g., subdivided) without being hampered or restricted by such underlying grid lines.

With reference to FIG. 4(b), a grid 406 is created. The grid 406 encompasses an entire area (e.g., an entire area of the reservoir) to be modelled. Accordingly, the grid 406 not only covers the grid block 404 but also a buffer area 408 adjacent to the grid block 404.

For purposes of LGR, the buffer area 408 may be subdivided into separate buffer grid blocks. As illustrated in FIG. 4(c), the buffer area 408 is subdivided into buffer grid blocks 408a, 408b, 408c, 408d, 408e, 408f, 408g, and 408h.

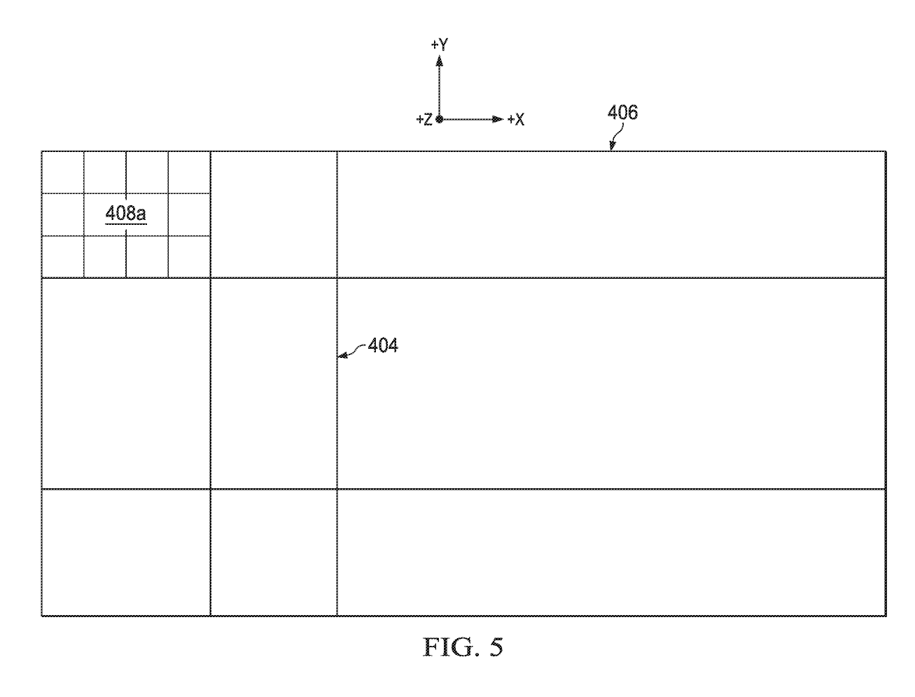

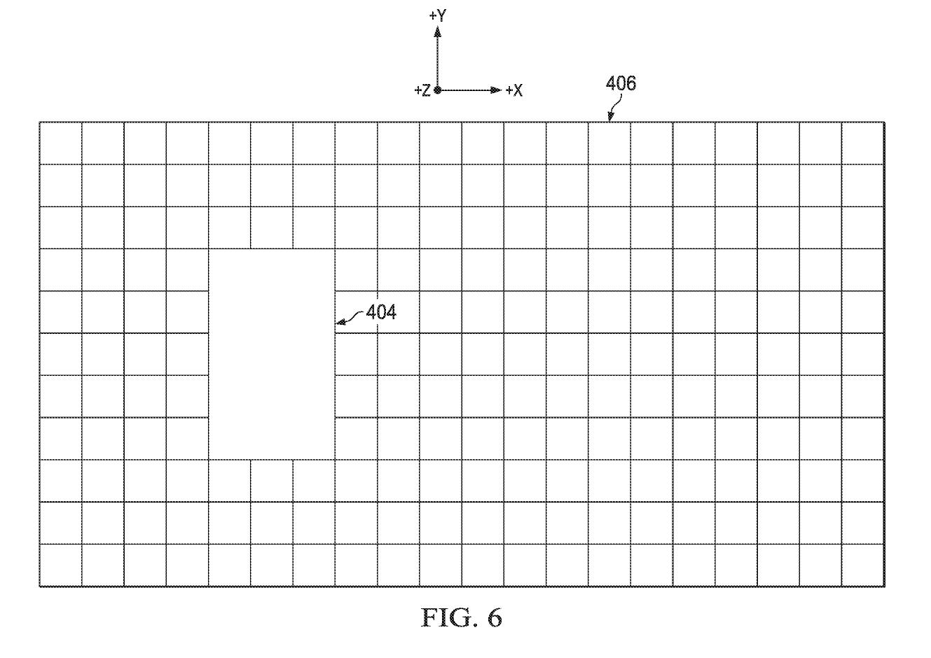

The buffer grid blocks 408a, 408b, 408c, 408d, 408e, 408f, 408g, and 408h may be refined. FIG. 5 illustrates an example in which the buffer grid block 408a is refined. FIG. 6 illustrates an example in which multiple buffer grid blocks 408a, 408b, 408c, 408d, 408e, 408f, 408g, and 408h are refined. In FIGS. 5 and 6, buffer grid blocks are illustrated as being subdivided in a uniform manner. However, it is understood that the buffer grid blocks may be subdivided in a non-uniform manner. Also, each of the buffer grid blocks may be refined in a manner (uniform or non-uniform) that is independent of the manner in which other buffer grid blocks are refined.

Grid block 404 is also refined. According to various embodiments, the grid block 404 is refined to provide a higher (finer) level of resolution relative to the buffer grid blocks 408a, 408b, 408c, 408d, 408e, 408f, 408g, and 408h. As such, parameters such as pressure, flow rate may be predicted more precisely in the geologic region represented by the grid block 404. As noted earlier, the refinement of the grid block 404 is performed without reference to an underlying simulation grid such as simulation grid 108 (or grid blocks 110 that make up a simulation grid). Accordingly, refinement of the grid block 404 can be performed without being hampered or restricted by borders associated with such a simulation grid (or its constituent grid blocks).

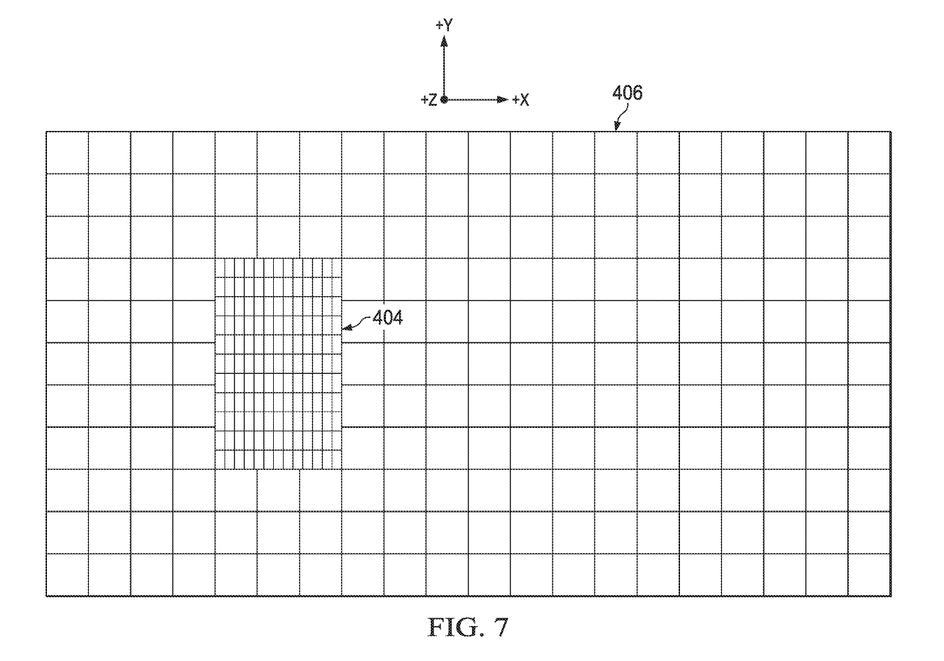

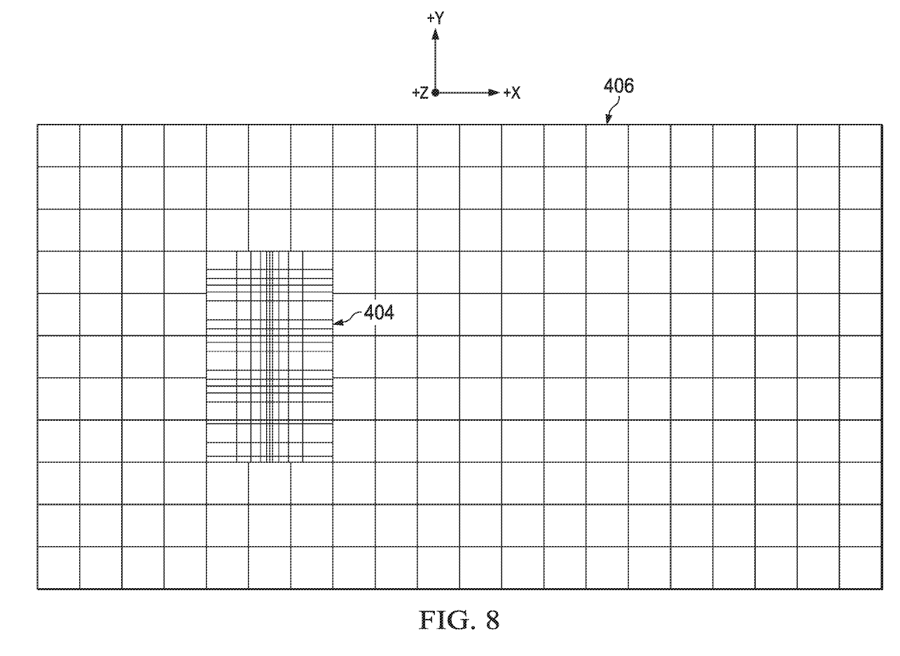

FIG. 7 illustrates an example of a uniform refinement of a grid block in an area of interest. With reference to FIG. 7, resolution in the grid block 404 is uniformly increased in the x- and y-directions. In other words, along the x- and y-directions, the grid block 404 is evenly divided into smaller blocks. FIG. 8 illustrates an example of a non-uniform refinement of a grid block. In more detail, FIG. 8 illustrates a non-uniform refinement of the grid block 404, where the grid block is sub-divided into blocks of different sizes. It is understood that refinement of the grid block 404 may be performed in another manner. For example, the grid block 404 may be subdivided into a combination of uniform and non-uniform blocks in the x-, y- and/or z-directions.

The refinement illustrated, e.g., with reference to FIGS. 7 and 8 is different from that described earlier with reference to FIG. 2. Notably, the refinement of FIGS. 7 and 8 can be performed without being hampered or restricted by underlying grid blocks. Furthermore, it is noted that the grid of FIG. 2 may be viewed as being constructed using two grids: the simulation grid 108 and the locally refined grid 212. In contrast, the grids of FIGS. 7 and 8 may be viewed as being constructed using a total of 10 grids: the grid 406, the grid block 404 and buffer grid blocks 408a, 408b, 408c, 408d, 408e, 408f, 408g, and 408h.

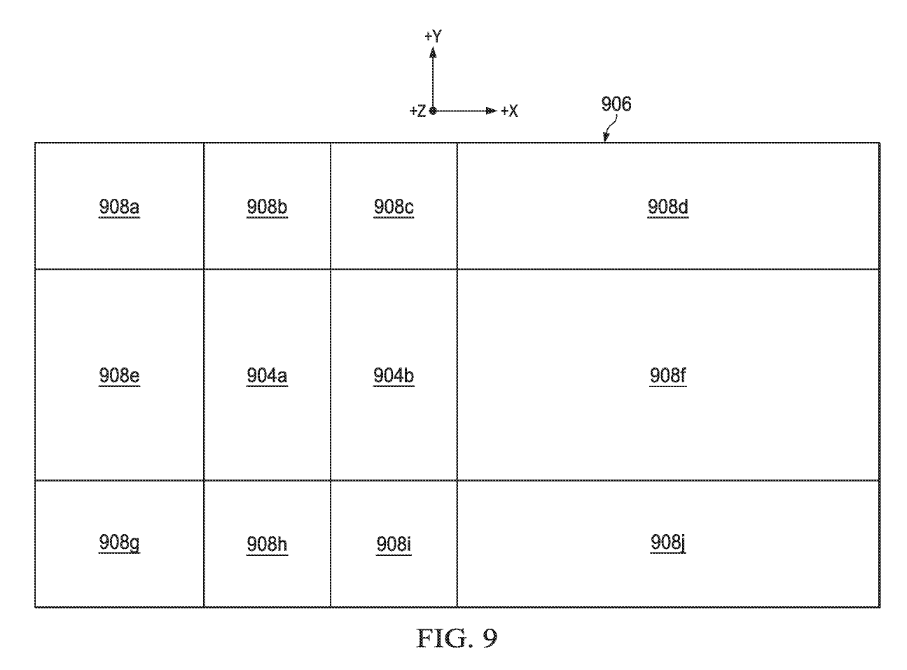

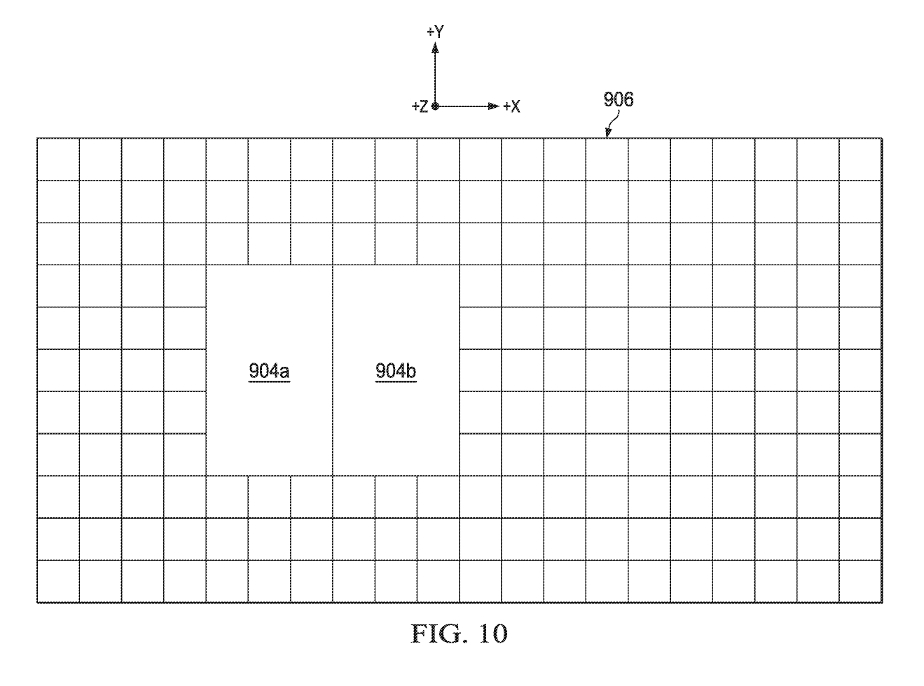

Construction of a grid based on a single area of interest has been described with reference to FIGS. 4(a), 4(b), and 4(c). According to other embodiments, a grid is constructed based on two or more areas of interest. For example, a grid that is constructed based on two areas of interest will be described with reference to FIGS. 9 and 10.

With reference to FIG. 9—in a representation of a geologic formation (e.g., a reservoir such as a shale reservoir), two specific structures are identified. For example, the structures may be fracture patterns. Grid blocks 904a, 904b are created to encompass the first structure and the second structure, respectively. Similar to the grid block 404, the grid blocks 904a, 904b are defined without reference to an underlying grid and/or underlying grid blocks (e.g., simulation grid 108 and/or grid blocks 110 of FIG. 1). As such, the dimensions of the grid blocks 904a, 904b can be selected irrespective of grid lines (or borders) that are associated with such constructs. Further, the grid blocks 904a, 904b can be refined (e.g., subdivided) without being hampered or restricted by such underlying grid lines.

With continued reference to FIG. 9, a grid 906 is created. The grid 906 encompasses an entire area (e.g., an entire area of the reservoir) to be modelled. Accordingly, the grid 906 not only covers the grid blocks 904a, 904b but also a buffer area adjacent to the grid blocks.

For purposes of LGR, the buffer area may be subdivided into separate buffer grid blocks. As illustrated in FIG. 9, the buffer area is subdivided into buffer grid blocks 908a, 908b, 908c, 908d, 908e, 908f, 908g, 908h, 908i, and 908j.

The buffer grid blocks 908a, 908b, 908c, 908d, 908e, 908f, 908g, 908h, 908i, and 908j may be refined. FIG. 10 illustrates an example in which the buffer grid blocks 908a, 908b, 908c, 908d, 908e, 908f, 908g, 908h, 908i, and 908j are refined. The buffer grid blocks are illustrated as being subdivided in a uniform manner. However, it is understood that the buffer grid blocks may be subdivided in a non-uniform manner. Also, each of the buffer grid blocks may be refined in a manner (uniform or non-uniform) that is independent of the manner in which other buffer grid blocks are refined.

Also, the grid blocks 904a, 904b are refined. According to various embodiments, the grid blocks 904a, 904b are refined to provide a finer level of resolution relative to the buffer grid blocks 908a, 908b, 908c, 908d, 908e, 908f, 908g, 908h, 908i, and 908j. As such, parameters including refined pressure and flow rate may be predicted more precisely in the geologic regions represented by the grid blocks 904a, 904b. As noted earlier, the refinement of the grid blocks 904a, 904b is performed without reference to an underlying simulation grid such as simulation grid 108 (or grid blocks 110 that make up a simulation grid). Accordingly, refinement of the grid blocks 904a, 904b can be performed without being hampered or restricted by borders associated with a simulation grid (or its constituent grid blocks).

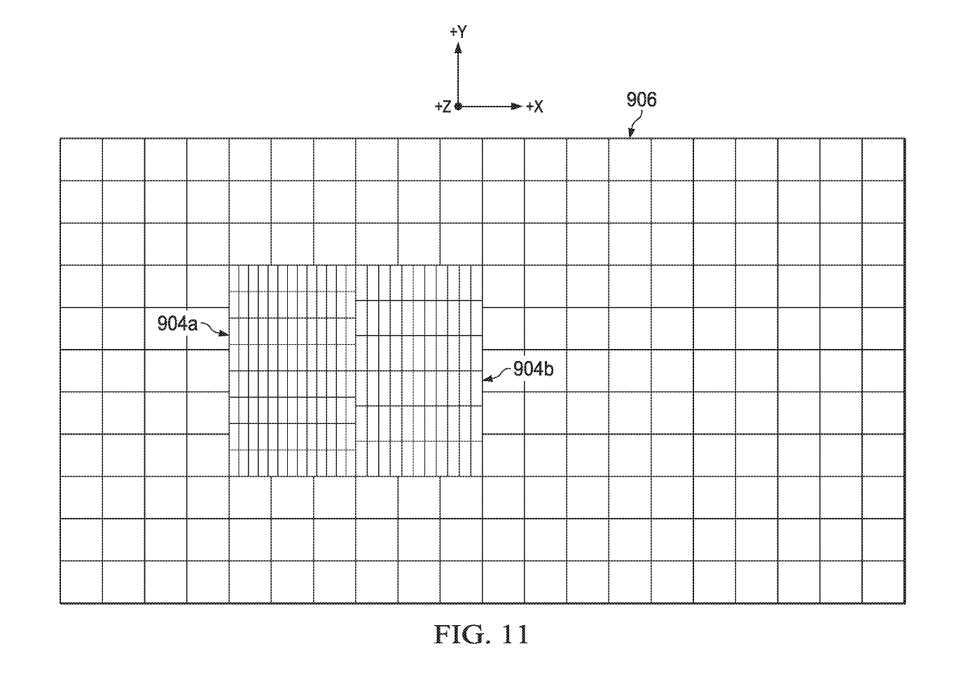

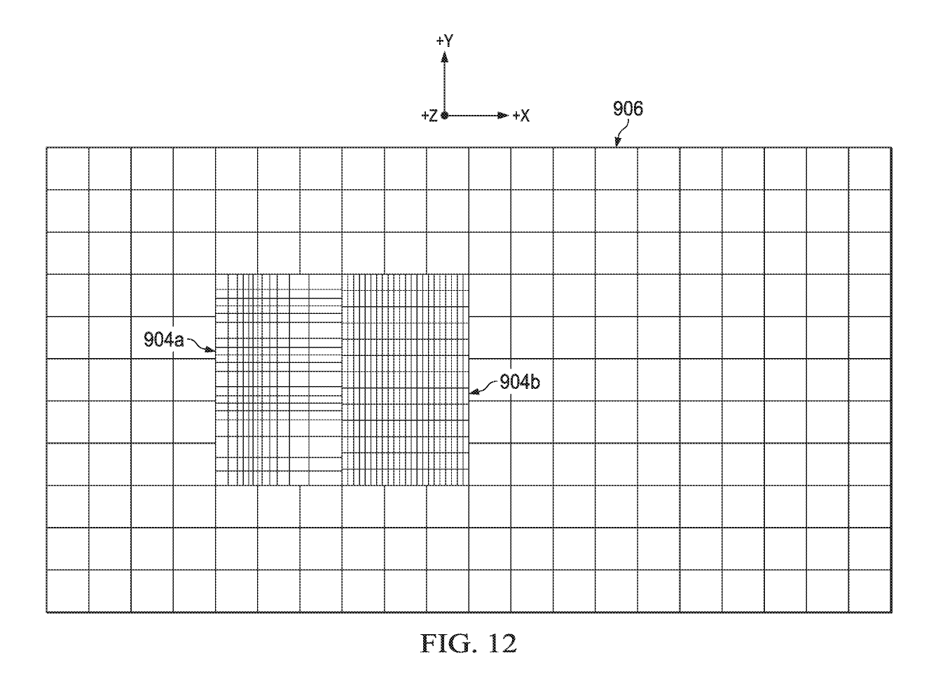

FIGS. 11 and 12 illustrate uniform and/or non-uniform refinement of multiple grid blocks (grid blocks 904a, 904b). With reference to FIG. 11, resolution in the grid block 904a is uniformly increased in the x- and y-directions, and resolution in the grid block 904b is uniformly increased in the x- and y-directions. In the example illustrated in FIG. 11, the increases in resolution of grid block 904a are different from the increases in resolution of grid block 904b. As such, multiple grid blocks may be refined to different degrees. FIG. 12 illustrates a non-uniform refinement of the grid block 904a, where the grid block is sub-divided into blocks of different sizes. Resolution in the grid block 904b is uniformly increased in the x- and y-directions. It is understood that refinement of the grid blocks 904a, 904b may be performed in another manner. For example, the grid block 904a and/or the grid block 904b may be subdivided into a combination of uniform and non-uniform blocks in the x-, y- and/or z-directions.

More generally, a grid may be constructed based on two or more areas of interest. For example, if NP denotes a nonzero number of areas of interest (e.g., fracture patterns) that are similar to the scenario described earlier with reference to FIG. 9, then a coarse grid may be defined. The coarse grid is composed of (NP+2) grid blocks along the x-direction. The coarse grid is composed of 3 grid blocks along the y-direction. In this situation, buffer grid blocks are provided adjacent to the NP grid blocks, which encompass the areas of interest. The resolution of each of the buffer grid blocks is refined as desired. Also, the resolution of the NP grid blocks is refined as desired for purposes of modeling the areas of interest.

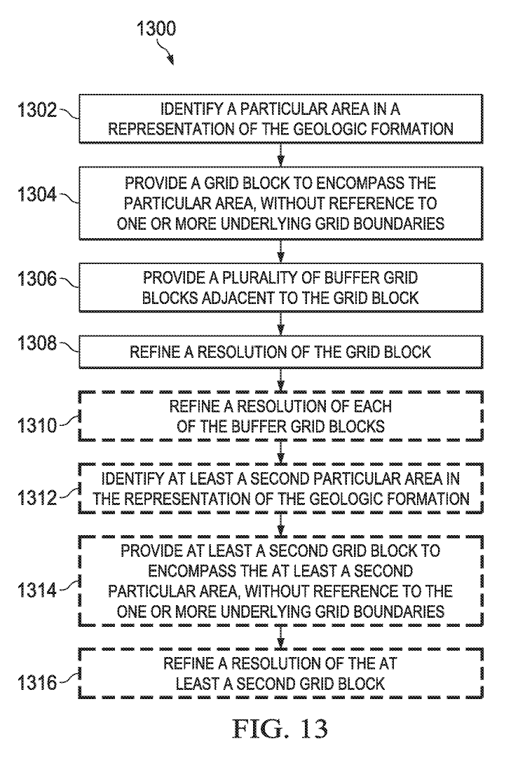

FIG. 13 is a flowchart showing an illustrative method 1300 of modeling a geologic formation (e.g., a subterranean reservoir). At block 1302, a particular area in a representation of the geologic formation is identified. For example, the particular area may correspond to a structure of interest (e.g., structure 402). At block 1304, a grid block (e.g., grid block 404) is provided to encompass the particular area, without reference to one or more underlying grid boundaries. At block 1306, buffer grid blocks (e.g., buffer grid blocks 408a, 408b, 408c, 408d, 408e, 408f, 408g, and 408h) are provided adjacent to the grid block. At block 1308, a resolution of the grid block is refined. Providing the grid block without reference to the one or more underlying grid boundaries allows the resolution of the grid block to be refined without restriction by the one or more underlying grid boundaries.

At block 1310, a resolution of each of the buffer grid blocks may be refined. At block 1312, a second particular area in the representation of the geologic formation is identified. (Alternatively, two or more additional particular areas in the representation of the geologic formation are identified.) At block 1314, a second grid block is provided to encompass the second particular area, without reference to the one or more underlying grid boundaries. (Alternatively, two or more additional grid blocks are provided to encompass the additional particular areas, without reference to the one or more underlying grid boundaries.) At block 1316, a resolution of the second grid block is refined. (Alternatively, resolutions of the additional grid blocks are refined.) Providing the second grid block without reference to the one or more underlying grid boundaries allows the resolution of the second grid block to be refined without restriction by the one or more underlying grid boundaries

Disclosed embodiments may be used to model the flow of oil, gas and water in the vicinity of particular structures in geologic formations (e.g., induced fractures in shale reservoirs). It is understood that features of these embodiments are similarly applicable in other types of reservoirs and processes, where parameters such as pressure change and fluid movement in the vicinity of wells or other important features are modeled. For example, disclosed features may be used in the coning of water and/or gas in the vicinity of wells.

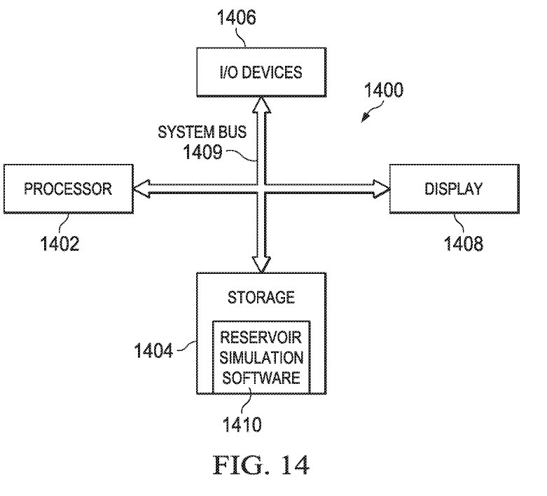

FIG. 14 is a simplified block diagram of a computer system 1400 adapted for implementing a reservoir simulation system. With reference to FIG. 14, the computer system 1400 includes at least one processor 1402, a non-transitory, computer-readable storage 1404, I/O devices 1406, and an optional display 1408, all interconnected via a system bus 1409.

Software instructions executable by the processor 1402 for implementing a reservoir simulation system in accordance with embodiments described herein, may be stored in storage 1404. Although not explicitly shown in FIG. 14, it will be recognized that the computer system 1400 may be connected to one or more public and/or private networks via appropriate network connections. It will also be recognized that the software instructions 1410 for implementing the reservoir simulation system may be loaded into storage 1404 from a CD-ROM or other appropriate storage media.

Embodiments disclosed herein include:

A: A related computing system includes a display and a processor coupled to the display. The processor is configured to: identify a particular area in a representation of a geologic formation displayed on the display; control the display to display a grid block to encompass the particular area, without reference to one or more underlying grid boundaries; control the display to display a plurality of buffer grid blocks adjacent to the grid block; and refine a resolution of the grid block. Controlling the display to display the grid block without reference to the one or more underlying grid boundaries allows the resolution of the grid block to be refined without restriction by the one or more underlying grid boundaries.

B. A method of modeling a geologic formation includes identifying a particular area in a representation of the geologic formation and providing a grid block to encompass the particular area, without reference to one or more underlying grid boundaries. The method also includes providing a plurality of buffer grid blocks adjacent to the grid block and refining a resolution of the grid block. Providing the grid block without reference to the one or more underlying grid boundaries allows the resolution of the grid block to be refined without restriction by the one or more underlying grid boundaries.

Each of the embodiments, A and B, may have one or more of the following additional elements in any combination. Element 1: wherein the processor is further configured to refine a resolution of each of the buffer grid blocks. Element 2: wherein the refined resolution of the grid block is higher than the refined resolution of each of the buffer grid blocks. Element 3: wherein the grid block and the plurality of buffer grid blocks form a shape of a rectangle. Element 4: wherein: the geologic formation comprises a subterranean reservoir; and the particular area corresponds to a region of interest in the subterranean reservoir. Element 5: wherein: the processor sizes the grid block based on a size of the region of interest; and the grid block is sized without restriction by the one or more underlying grid boundaries. Element 6: wherein the region of interest comprises a fracture pattern of a shale reservoir. Element 7: wherein the processor refines the resolution of the grid block by uniformly subdividing the grid block with respect to at least one dimension. Element 8: wherein the processor refines the resolution of the grid block by non-uniformly subdividing the grid block with respect to at least one dimension. Element 9: wherein the processor is further configured to: identify at least a second particular area in the representation of the geologic formation; control the display to display at least a second grid block to encompass the at least a second particular area, without reference to the one or more underlying grid boundaries; and refine a resolution of the at least a second grid block, and wherein displaying the at least a second grid block without reference to the one or more underlying grid boundaries allows the resolution of the at least a second grid block to be refined without restriction by the one or more underlying grid boundaries.

Element 10: further comprising refining a resolution of each of the buffer grid blocks. Element 11: wherein the refined resolution of the grid block is higher than the refined resolution of each of the buffer grid blocks. Element 12: wherein the grid block and the plurality of buffer grid blocks form a shape of a rectangle. Element 13: wherein: the geologic formation comprises a subterranean reservoir; and the particular area corresponds to a region of interest in the subterranean reservoir. Element 14: wherein: providing the grid block comprises sizing the grid block based on a size of the region of interest; and the grid block is sized without restriction by the one or more underlying grid boundaries. Element 15: wherein the region of interest comprises a fracture pattern of a shale reservoir. Element 16: wherein refining the resolution of the grid block comprises uniformly subdividing the grid block with respect to at least one dimension. Element 17: wherein refining the resolution of the grid block comprises non-uniformly subdividing the grid block with respect to at least one dimension. Element 18: further comprising: identifying at least a second particular area in the representation of the geologic formation; providing at least a second grid block to encompass the at least a second particular area, without reference to the one or more underlying grid boundaries; and refining a resolution of the at least a second grid block, wherein providing the at least a second grid block without reference to the one or more underlying grid boundaries allows the resolution of the at least a second grid block to be refined without restriction by the one or more underlying grid boundaries.

Numerous variations and modifications will become apparent to those skilled in the art once the above disclosure is fully appreciated. The methods and systems can be used for modeling a reservoir and modeling the flow (e.g., of oil, gas and water), particularly in the vicinity of areas or structures of interest (e.g., fracture patterns). The ensuing claims are intended to cover such variations where applicable.

What is claimed is:

1. A method of modeling a geologic formation, comprising:
identifying a particular area in a representation of the geologic formation;
providing a grid block to encompass the particular area, without reference to one or more underlying grid boundaries;
providing a plurality of buffer grid blocks adjacent to the grid block; and
refining a resolution of the grid block,
wherein providing the grid block without reference to the one or more underlying grid boundaries allows the resolution of the grid block to be refined without restriction by the one or more underlying grid boundaries.

2. The method of claim 1, further comprising refining a resolution of each of the buffer grid blocks.

3. The method of claim 2, wherein the refined resolution of the grid block is higher than the refined resolution of each of the buffer grid blocks.

4. The method of claim 1, wherein the grid block and the plurality of buffer grid blocks form a shape of a rectangle.

5. The method of claim 1, wherein:
the geologic formation comprises a subterranean reservoir; and
the particular area corresponds to a region of interest in the subterranean reservoir.

6. The method of claim 5, wherein:
providing the grid block comprises sizing the grid block based on a size of the region of interest; and
the grid block is sized without restriction by the one or more underlying grid boundaries.

7. The method of claim 5, wherein the region of interest comprises a fracture pattern of a shale reservoir.

8. The method of claim 1, wherein refining the resolution of the grid block comprises uniformly subdividing the grid block with respect to at least one dimension.

9. The method of claim 1, wherein refining the resolution of the grid block comprises non-uniformly subdividing the grid block with respect to at least one dimension.

10. The method of claim 1, further comprising:
identifying at least a second particular area in the representation of the geologic formation;
providing at least a second grid block to encompass the at least a second particular area, without reference to the one or more underlying grid boundaries; and
refining a resolution of the at least a second grid block,
wherein providing the at least a second grid block without reference to the one or more underlying grid boundaries allows the resolution of the at least a second grid block to be refined without restriction by the one or more underlying grid boundaries.

11. A computing system comprising:
a display; and
a processor coupled to the display and configured to:
identify a particular area in a representation of a geologic formation displayed on the display;
control the display to display a grid block to encompass the particular area, without reference to one or more underlying grid boundaries;
control the display to display a plurality of buffer grid blocks adjacent to the grid block; and
refine a resolution of the grid block,
wherein controlling the display to display the grid block without reference to the one or more underlying grid boundaries allows the resolution of the grid block to be refined without restriction by the one or more underlying grid boundaries.

12. The computing system of claim 11, wherein the processor is further configured to refine a resolution of each of the buffer grid blocks.

13. The computing system of claim 12, wherein the refined resolution of the grid block is higher than the refined resolution of each of the buffer grid blocks.

14. The computing system of claim 11, wherein the grid block and the plurality of buffer grid blocks form a shape of a rectangle.

15. The computing system of claim 11, wherein:
the geologic formation comprises a subterranean reservoir; and
the particular area corresponds to a region of interest in the subterranean reservoir.

16. The computing system of claim 15, wherein:
the processor sizes the grid block based on a size of the region of interest; and
the grid block is sized without restriction by the one or more underlying grid boundaries.

17. The computing system of claim 15, wherein the region of interest comprises a fracture pattern of a shale reservoir.

18. The computing system of claim 11, wherein the processor refines the resolution of the grid block by uniformly subdividing the grid block with respect to at least one dimension.

19. The computing system of claim 11, wherein the processor refines the resolution of the grid block by non-uniformly subdividing the grid block with respect to at least one dimension.

20. The computing system of claim 11,
wherein the processor is further configured to:
identify at least a second particular area in the representation of the geologic formation;
control the display to display at least a second grid block to encompass the at least a second particular area, without reference to the one or more underlying grid boundaries; and
refine a resolution of the at least a second grid block, and
wherein displaying the at least a second grid block without reference to the one or more underlying grid boundaries allows the resolution of the at least a second grid block to be refined without restriction by the one or more underlying grid boundaries.
